(19) United States
(12) Patent Application Publication
(10) Pub. No.: US 2010/0289422 A1
(43) Pub. Date: Nov. 18, 2010

(54) PIEZOELECTRIC TYPE RESONANCE HIGH-VOLTAGE LIGHT-STARTING CIRCUIT

(76) Inventor: Tao-Chin WEI, Taipei City (TW)

Correspondence Address: Muncy, Geissler, Olds & Lowe, PLLC, 4000 Legato Road, Suite 310, FAIRFAX, VA, 22033, US

(21) Appl. No.: 12/506,607

(22) Filed: Jul. 21, 2009

(30) Foreign Application Priority Data
May 15, 2009 (TW) 098208545

(51) Int. Cl. H05B 37/00

(52) U.S. Cl. 315/239; 315/244

(57) ABSTRACT

A piezoelectric type resonance high-voltage light-starting circuit, wherein, the intrinsic capacitance characteristic of a piezoelectric transformer is utilized as a piezoelectric capacitor, and said piezoelectric transformer connected to a light tube is connected in series with an independent inductor, thus forming a resonance type series-connected or parallel-connected light-starting circuit, hereby achieving the efficacy of small leakage current, low operating temperature, and high voltage endurance, as such raising the light-starting efficiency. Furthermore, in the application of said circuit mentioned above, output voltage is further amplified through a booster transformer, thus achieving its characteristics of high illuminance. When driving said plurality of light tubes, a fixed frequency is utilized in making an intrinsic impedance of an equivalent circuit containing said piezoelectric capacitor to be fixed at a constant value, thus current flowing in each of said light tubes is equivalent, and achieving balance of currents in said plurality of light tubes.

### BACKGROUND OF THE INVENTION

1. Field of the Invention

The present invention relates to a resonance light-starting circuit, and in particular to a piezoelectric type resonance high-voltage light-starting circuit having an independent inductor series-connected or parallel connected with a piezoelectric transformer.

2. The Prior Arts

In general, the lighting principle of Cold Cathode Fluorescence Lamp (CCIF) is the same as that of an ordinary fluorescence lamp, and its lighting principle is that: when a high voltage is input through a terminal of an electrode of a light tube, such that in the light tube, the electrons and molecules are induced to impact on the electrode at high speed, thus generating secondary electron emission. When the electric discharge begins, the electrons will collide with mercury atoms, thus the agitated mercury atoms will radiate 253.7 nm ultra-violet (UV) light, and that will stimulate the fluorescent powder coated on the wall of a light tube in generating visible lights of corresponding color temperature. For this reason, in general, CCFL is applicable to displayer, personal data assistant (PDA), digital camera, and handset. Moreover, it is an indispensable component for backlight of a liquid crystal display (LCD).

However, due to the ever increasing applications of liquid crystal display, such that its size is getting increasingly large, therefore, the number of CCFL utilized for backlight has to be increased correspondingly, so as to maintain the same or higher illuminance. Due to the demand for even distribution of illuminance and prolonged service life of light tube, the absolute value of light tube current and its relative difference must be stringently controlled. For a multi light-tube module of the prior art, a conventional coil type booster transformer is parallel-connected with a light tube. However, the disadvantage of this coil type booster transformer is that: its efficiency is not good, and the voltage endurance of coil is not sufficient, thus it is liable be broken down due to sudden jump of power supply to a very high voltage, hereby resulting in a short circuit and burning out the coil, as such, it is highly hazardous. For a structure of another multi light-tube module, refer to FIG. 1. As shown in FIG. 1, the current difference between light tubes 100 is compensated by a capacitor 110 series connected to a high voltage terminal of a light tube 100, therefore, this tends to cause large leakage current, and its efficiency is not quite satisfactory. In addition, the voltage endurance of capacitor 110 is not sufficient, a malfunction capacitor 110 tends to explode, and is liable to induce danger of catching fire.

On the other hand, since in the application of U-shaped light tube as backlight, the quantity of light tubes and inverters utilized can be drastically reduced. Therefore, due to cost considerations, U-shaped light tubes are utilized in large quantity in the industry. However, due to the fact that a portion of current and voltage in the bent portions of a U-shaped tube is liable to be lost, as such, sufficient voltage has to be provided in order to achieve the same lighting efficiency as that of a straight and long light tube. Therefore, the research and development of a high-voltage lighting circuit capable of achieving high lighting efficiency and balanced tube current is probably one of the most urgent tasks in this field.

### SUMMARY OF THE INVENTION

In view of the problems and shortcomings of the prior art, the present invention discloses a piezoelectric type resonance high-voltage light-starting circuit, so as to overcome the shortcomings and problems of the prior art.

A major objective of the present invention is to provide a piezoelectric type resonance high-voltage light-starting circuit, wherein, the capacitance characteristics of a piezoelectric transformer is utilized as a piezoelectric capacitor in forming a resonance light-starting circuit having its inductor series-connected or parallel-connected with a piezoelectric transformer, thus it is capable of fulfilling the requirements of small leakage current, high light-starting efficiency, and current balance. Furthermore, a booster transformer is connected to an output terminal of the circuit for further amplifying the output voltage, thus facilitating light-starting at high voltage.

Another objective of the present invention is to provide a piezoelectric type resonance high-voltage light-starting circuit, wherein, a piezoelectric transformer is used to replace the a capacitor or a coil-type booster transformer in a conventional light-starting circuit, hereby achieving smaller size and superior electrical efficacy, and is capable of avoiding the danger of malfunction and overheating due to insufficient voltage endurance. Therefore, its reliability is high, and has a good competitive edge in market competition.

A further objective of the present invention is to provide a piezoelectric type resonance high-voltage light-starting circuit, wherein, series-connection is adopted in reducing length of wirings utilized, so as to realize the compact size of the final product.

Therefore, in order to achieve the above-mentioned objective, the present invention provides a piezoelectric type resonance high-voltage light-starting circuit, wherein, a piezoelectric ceramic oscillator plate originally used in high power supersonic wave oscillator is instead utilized in a ballast and an inverter of a resonance light-starting circuit as piezoelectric capacitor. The resonance light-starting circuit having the characteristic that its voltage boost ratio can be varied according to the intrinsic impedance of a load, and that is very suitable for use in driving a light tube. As such, when a light tube is not activated, it is equivalent to be in an open circuit state, at this time, the resonance light-starting circuit can provide fairly high voltage boost ratio in activating and turning on the light tube instantaneously; and when the light tube is activated, the equivalence impedance decreases, so the voltage boost ratio of the circuit also decreases, such that the light tube can operate normally in a stable state.

In order to meet the requirement of large current and high illuminance, in the present invention, a booster transformer is utilized to raise output voltage to a level required, then the raised voltage is provided to two ends of the respective light tubes, hereby raising the efficiency of power, providing output of high illuminance and shortening the light tube starting time, thus protecting the proper operations of a light tube.

Meanwhile, the present invention can be applicable in balancing currents in a plurality of light tubes. The intrinsic impedance of an equivalent circuit containing a piezoelectric capacitor is fixed at a constant value through utilizing a fixed frequency, hereby forming a constant current flowing through the light tubes. When the electrical characteristic of a piezoelectric capacitor connected in series with a light tube is close to that of each of the piezoelectric capacitors connected in series with other light tubes, then their intrinsic impedance values are close to each other, so that the current flowing in each of the light tubes is equivalent, thus achieving current balance of light tubes.

In addition, in the present invention, a piezoelectric capacitor may cooperate with an independent inductor in forming a framework of a resonance light-starting circuit, and that is suitable for use in a double high-voltage light starting in a full-bridge circuit; and of course, it is also suitable for use in a single high-voltage light starting in a half-bridge circuit.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The related drawings in connection with the detailed description of the present invention to be made later are described briefly as follows, in which:

FIG. 1 is a circuit diagram of a multi light-tube module utilizing ordinary capacitors according to the prior art;

FIG. 2A is a circuit diagram of a piezoelectric type resonance high-voltage light-starting circuit according to an embodiment of the present invention, wherein, piezoelectric capacitor is series connected with a resonance inductor;

FIG. 2B is a circuit diagram of a piezoelectric type resonance high-voltage light-starting circuit according to an embodiment of the present invention, wherein, piezoelectric capacitor is parallel connected with a resonance inductor;

FIG. 3 is a schematic diagram of elements of a piezoelectric capacitor according to an embodiment of the present invention;

FIGS. 4A & 4B are circuit diagrams of a piezoelectric type resonance high-voltage light-starting circuit having full-bridge output according to an embodiment of the present invention;

FIGS. 5A & 5B are circuit diagrams of a structure formed by applying piezoelectric type resonance high-voltage light-starting circuit to an External Electrode Fluorescent Lamp (EEFL) according to an embodiment of the present invention;

FIGS. 6A & 6B are circuit diagrams of a structure formed by applying piezoelectric type resonance high-voltage light-starting circuit to a light-emitting-diode (LED) according to an embodiment of the present invention;

FIGS. 7A & 7B are circuit diagrams of a structure formed by applying piezoelectric type resonance high-voltage light-starting circuit to a Compact Fluorescent Lamp (CFL) according to an embodiment of the present invention;

FIGS. 8A & 8B are circuit diagrams of piezoelectric type resonance high-voltage light-starting circuit having full-bridge input according to an embodiment of the present invention;

FIGS. 9A & 9B are circuit diagrams of piezoelectric type resonance high-voltage light-starting circuit having half-bridge input according to an embodiment of the present invention; and

FIG. 10 is a circuit diagram of an equivalent circuit of a piezoelectric capacitance according to an embodiment of the present invention.

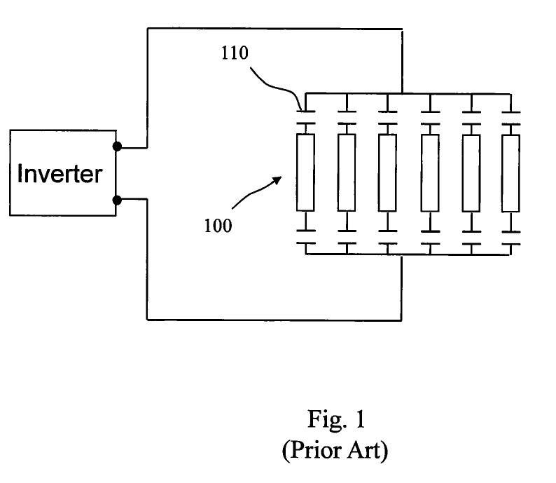

### DETAILED DESCRIPTION OF THE PREFERRED EMBODIMENT

The purpose, construction, features, functions and advantages of the present invention can be appreciated and understood more thoroughly through the following detailed descriptions with reference to the attached drawings.

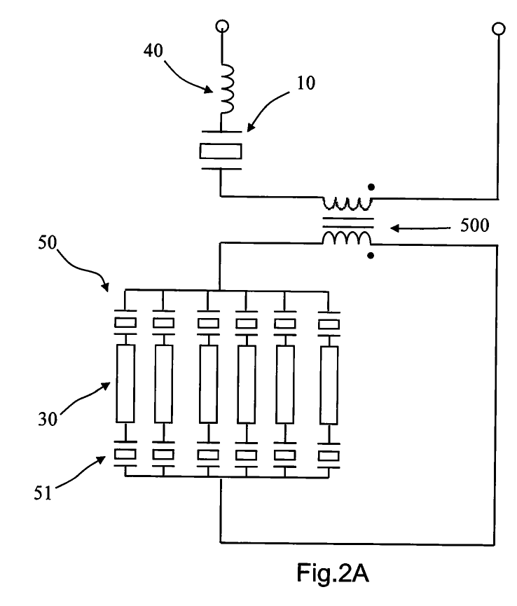

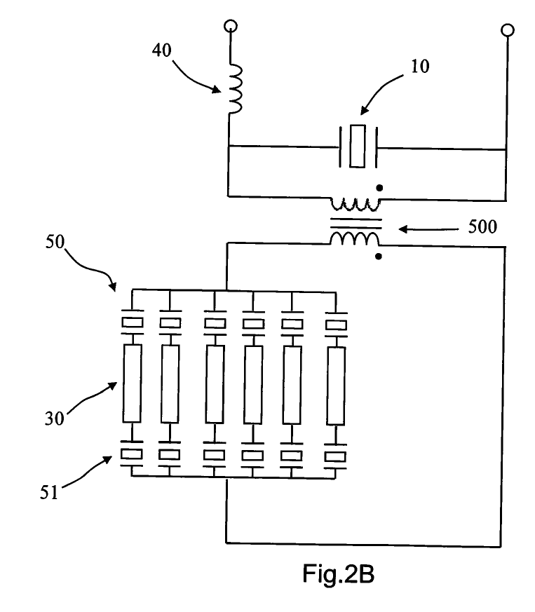

Refer to FIG. 2A for a circuit diagram of a piezoelectric type resonance high-voltage light-starting circuit according to an embodiment of the present invention. As shown in FIG. 2A, the piezoelectric type resonance high-voltage light-starting circuit mainly includes a plurality sets of cold cathode fluorescence lamps (CCFL) 30, with each set of CCFL connected in series between two auxiliary capacitors 50 and 51, each of the plurality sets of CCFLs 30 is connected to each other in parallel, then the connected set of CCFLs is coupled to a booster transformer 500, and that is series-connected to a resonance inductor 40 and a piezoelectric capacitor 10. In this piezoelectric type resonance high-voltage light-starting circuit, the capacitor characteristic of the piezoelectric transformer itself is used to serve as piezoelectric capacitor 10, and that is connected in series with a resonance inductor 40, hereby forming a resonance light-starting circuit having an inductor in series connection with a piezoelectric transformer, such that a voltage boost light-starting function can be achieved through adjusting resonance inductor 40 and the capacitance of the piezoelectric transformer. Meanwhile, the output amplified characteristic of a booster transformer 500 is utilized in raising the output voltage to a level required, such that the raised voltage is supplied to the two ends of CCFL 30 in achieving the required output level of high illuminance, thus facilitating light-starting at high voltage and achieving short light-starting time duration for better protection of a light tube.

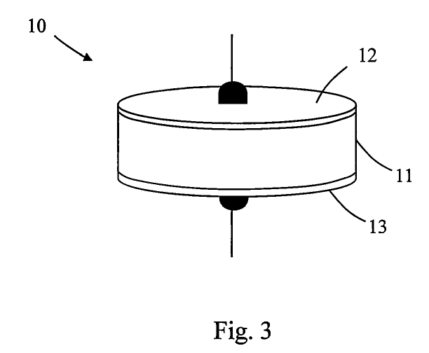

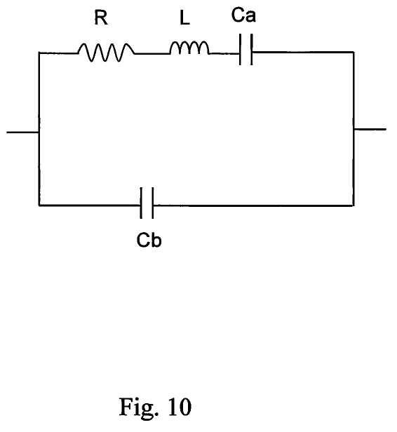

The structure of a piezoelectric capacitor 10 is as shown in FIG. 3. As shown in FIG. 3, a piezoelectric substrate 11 of a round plate shape is made of piezoelectric material, of course, other shapes are possible, such as square shape or rectangular shape, conduction layers 12 and 13 of the same round shape can be made of silver paste, copper paste, or nickel paste on an upper surface and a lower surface of the whole or a part of the piezoelectric substrate 11, thus forming the two electrodes of a piezoelectric capacitor 10 for conducting a current. Herein, refer to FIG. 10 for a circuit diagram of an equivalent circuit of piezoelectric capacitors 10. In the equivalent circuit is shown an equivalent resistor R, an equivalent inductor L, and an equivalent capacitors Cb and Ca representing the mechanic characteristic and the electric characteristic respectively. The differences between the piezoelectric capacitor 10 and an ordinary capacitor of coil type booster transformer are that: firstly, for the piezoelectric capacitor 10 of the present embodiment, the leakage current is smaller, the voltage endurance is higher, and without the danger of overheating for catching fire, therefore it reliability is high and is capable of providing raised output power of several-fold, thus raising the light-starting efficiency; secondly, since the piezoelectric capacitor is of small size and thin package thickness, in addition to the arrangement of series-connected resonance inductor, piezoelectric capacitor, and the light tube, such that the overall length of wirings utilized can be reduced, thus realizing a compact size of the final product.

In the present embodiment, a piezoelectric capacitor 10 is in series connection with a resonance inductor 40, however, in practice, the present invention is not limited to this. As shown in FIG. 2B, the piezoelectric capacitor 10 may also be connected in parallel with a resonance inductor 40. Compared with the parallel connection, the series connection utilized in the present invention is capable of maintaining lower temperature, hereby resulting in less power loss and consumption. In addition, auxiliary capacitors 50 and 51 can also be piezoelectric capacitors. As such, in addition to providing light-starting functions, it can be used to adjust the magnitude of capacitance, hereby generating fine-tuning for the output current, and achieving optimization of output power. When starting light tubes, the voltage will increase instantaneously; while upon finishing starting light tubes, the intrinsic impedance tends to decrease, thus the voltage boost ratio will decrease. Therefore, the output can be regulated for reducing additional power consumption.

Moreover, in the present invention, the piezoelectric type resonance high-voltage light-starting circuit having an inductor series-connected to a piezoelectric transformer can be utilized to effectively maintain current balance in a plurality of light tubes. When an input power source voltage is converted into an alternative current (AC) voltage required in driving a light-starting circuit, a piezoelectric capacitor is used to boost the low voltage to a high voltage required for starting the light tube. Due to the differences of impedance characteristics of light tubes, the differences of light tube currents will result in non-uniformity of backlight illuminance and reduction of service life of light tubes. Therefore, in the present invention, a fixed frequency is utilized to drive a resonance light-starting circuit, so as to make the intrinsic impedance of an equivalence circuit containing a piezoelectric capacitor remain at a constant value, thus forming a constant current flowing through light tubes. When the electrical characteristic of a piezoelectric capacitor connected in series with a light tube is close to that of each of the piezoelectric capacitors connected in series with other light tubes, then their intrinsic impedance values are close to each other, such that the current in each of the light tubes is equivalent, in other words, thus achieving current balance for a plurality of light tubes.

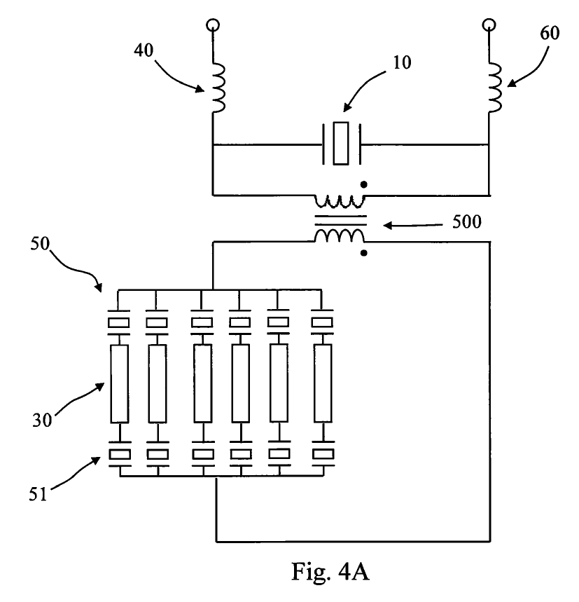

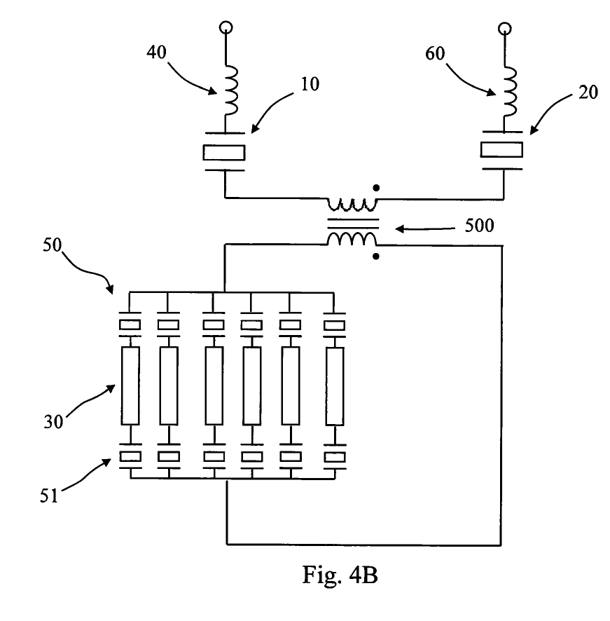

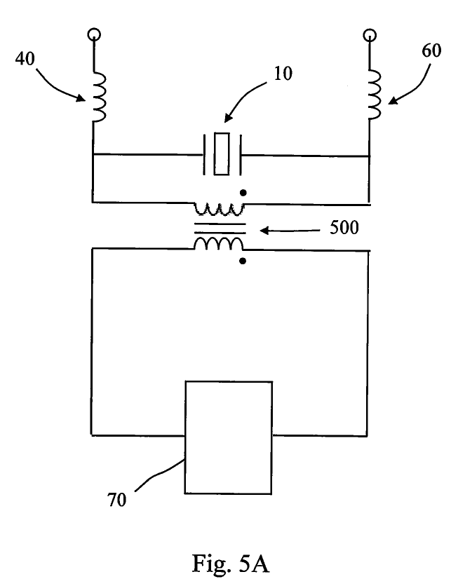

In the embodiment mentioned above, each of the light tubes 30 is provided with a piezoelectric capacitor 10 and a resonance inductor 40 to form a half-bridge resonance circuit, thus being capable of reducing production cost and having advantages in price competition. Of course, in case that two resonance inductors 40 and 60 are provided in forming a full-bridge resonance circuit, then the circuit thus formed is able to drive output elements requiring higher power level as shown in FIGS. 4A & 4B. In FIG. 4A is shown an embodiment, wherein, two resonance inductors 40 and 60 are connected in parallel with a piezoelectric capacitor 10 respectively; while in FIG. 4B is shown another embodiment, wherein, two resonance inductors 40 and 60 are connected in series with two piezoelectric capacitors 10 and 20 respectively.

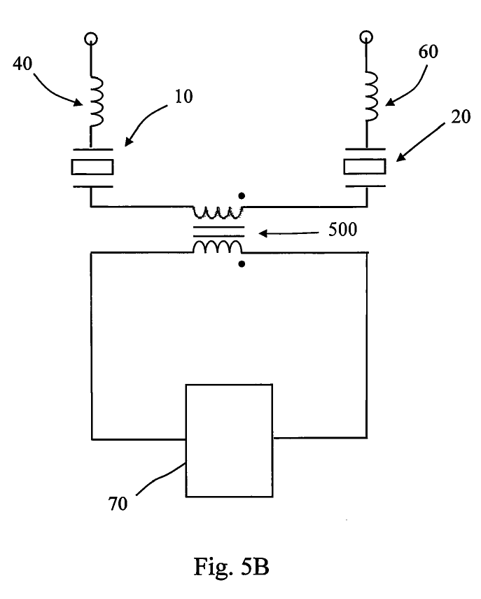

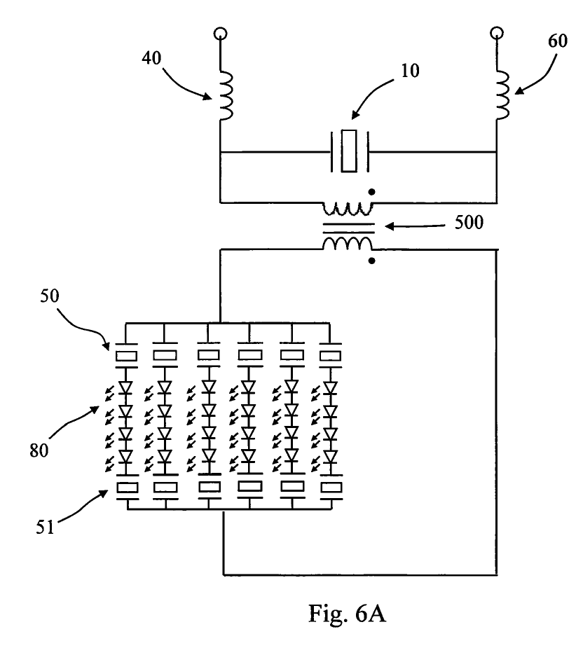

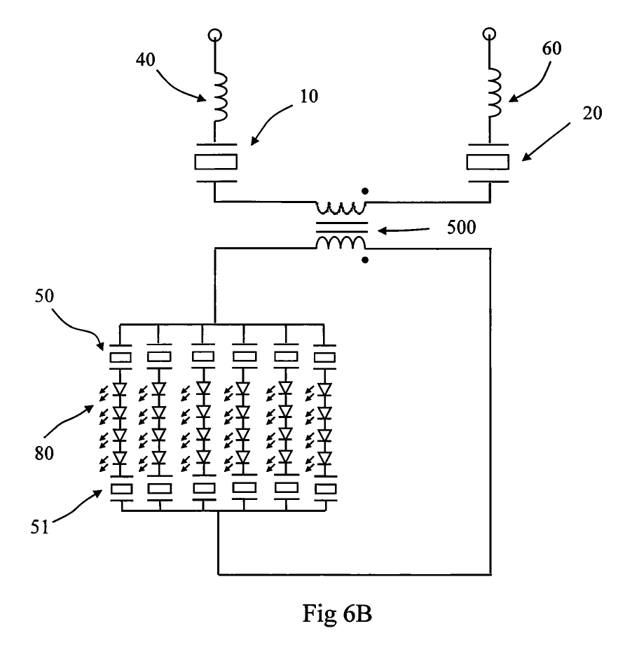

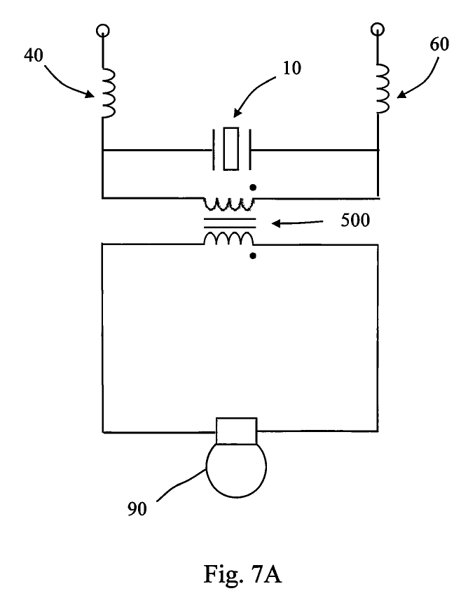

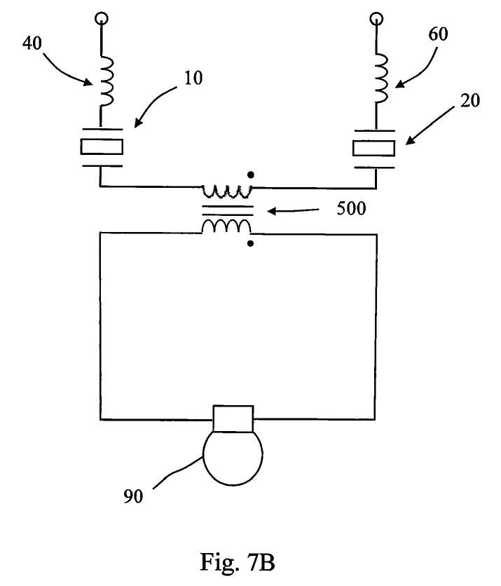

In addition, the piezoelectric type resonance high-voltage light-starting circuit of the present invention can be utilized in a single piece of the following: a High-Intensity-Discharge Lamp (HID), a Metal Halide Lamp, a Ceramic Poles Fluorescent Lamp (CPFL), a Cold Cathode Fluorescence Lamp (CCFL), an External Electrode Fluorescent Lamp (EEFL), a Compact Fluorescent Lamp (CFL), or a Light Emitting Diode (LED); also the piezoelectric type resonance high-voltage light-starting circuit of the present invention can be utilized in a plurality of parallel-connected pieces of the following: Cold Cathode Fluorescence Lamp (CCFL), External Electrode Fluorescent Lamp (EEFL), Compact Fluorescent Lamp (CFL), or Light Emitting Diode (LED). Refer to FIGS. 5A & 5B, 6A & 6B, and 7A & 7B respectively for schematic diagrams showing application of a piezoelectric type resonance high-voltage light-starting circuit of the present invention into an External Electrode Fluorescent Lamp (EEFL) 70 (or a High-lntensity-Discharge Lamp (HID), a Metal Halide Lamp, a Ceramic Poles Fluorescent Lamp (CPFL)), a Light Emitting Diode (LED) 80, and a Compact Fluorescent Lamp (CFL) 90. In the structure mentioned above, two resonance inductors 40 and 60 are connected in parallel with a piezoelectric capacitor 10 respectively; or alternatively, resonance inductors 40 and 60 can be connected in series with two piezoelectric capacitors 10 and 20 respectively. Of course, the configurations of the applications mentioned above can be a half-bridge or full-bridge resonance circuit.

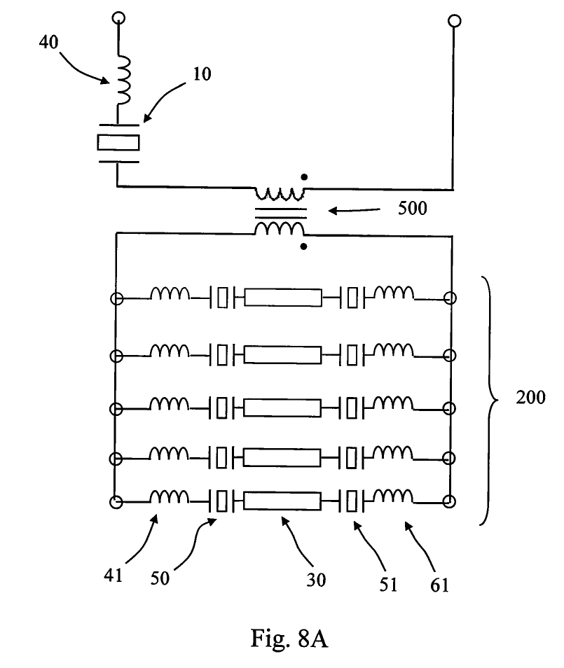

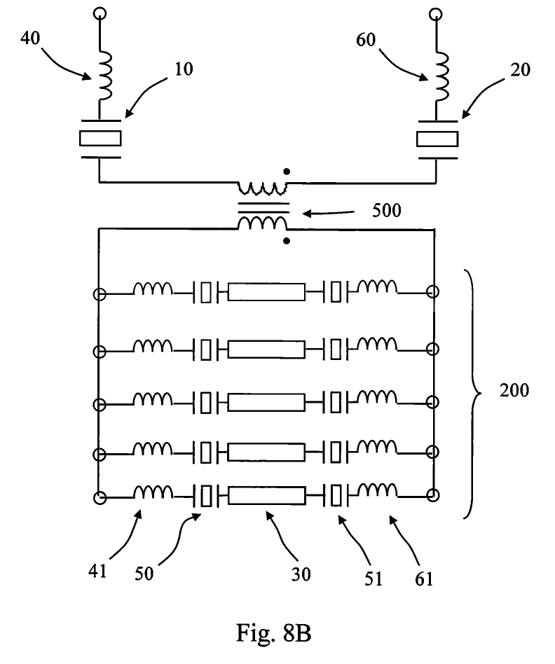

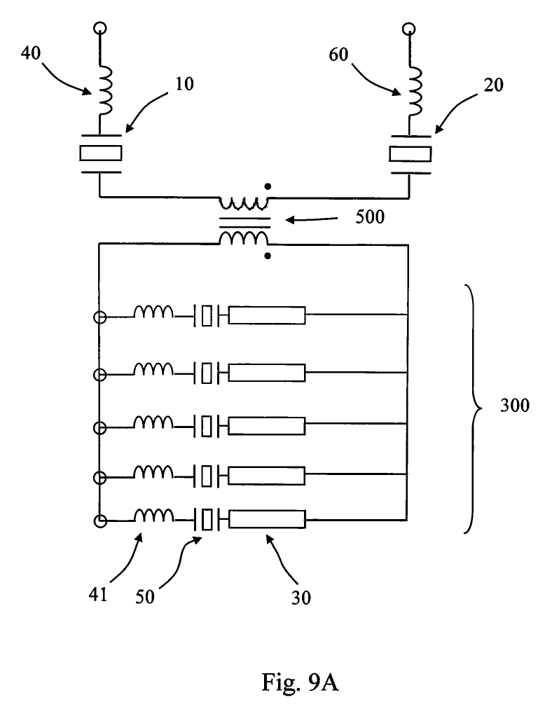

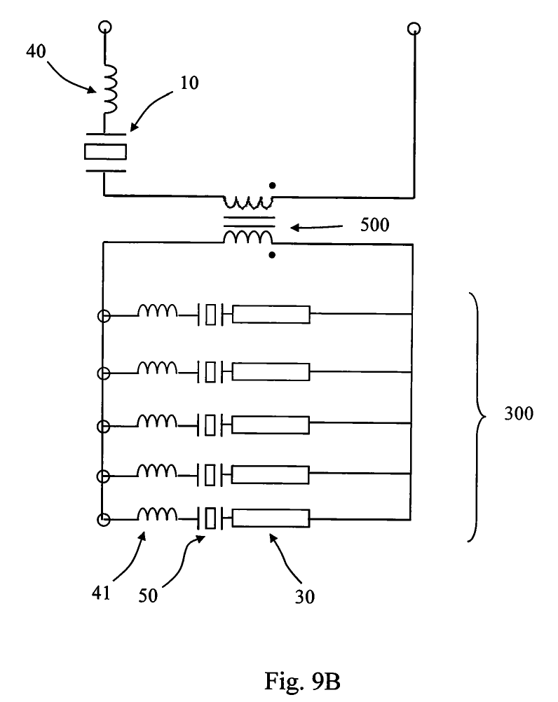

Furthermore, the piezoelectric type resonance high-voltage light-starting circuit of the present invention can be utilized in a large-sized backlight panel (for example, over 42 inches). Usually, this kind of large-sized backlight panel requires installation of long light tube (for example, over 1 meter in length), such that the capacitance loss rate in light tube is rather high, that is liable to create differences of illuminance among light tubes. In this situation, each of the respective light tubes requires an independent resonance inductor and a piezoelectric capacitor in balancing the current. Refer to FIGS. 8A & 8B, 9A & 9B, wherein, a double high voltage (full-bridge) and single high voltage (half-bridge) input piezoelectric type resonance high-voltage light-starting circuits 200 and 300 are taken as examples for explanation. As shown in FIGS. 8A & 8B, each of a plurality of light tubes 30 is series-connected between two auxiliary capacitors 50 and 51, and two resonance inductors 41 and 61; or, alternatively, as shown in FIGS. 9A & 9B, each of a plurality of light tubes 30 can be series connected to an auxiliary capacitor 10 and a resonance inductor 41, and then they are connected together in parallel, thus realizing a backlight as required. Of course, the present invention is particularly suitable for use in a U-shape light tube, hereby providing output of high illuminance, facilitating light-starting at high voltage, achieving short light-starting time, and prolonging service life of a light tube.

The above detailed description of the preferred embodiments is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A piezoelectric type resonance high-voltage light-starting circuit, comprising:
a piezoelectric capacitor, including a piezoelectric substrate and two conduction layers, said piezoelectric substrate is provided with an upper surface and a lower surface, and said two conduction layers are formed respectively on said upper surface and said lower surface of said piezoelectric substrate, thus forming two electrodes of said piezoelectric capacitor;
a resonance inductor, connected in series or in parallel with said piezoelectric capacitor; and
a booster transformer, electrically coupled to said piezoelectric capacitor and a light tube, hereby providing higher voltage to said light tube.

2. The piezoelectric type resonance high-voltage light-starting circuit as claimed in claim 1, wherein
a number of said resonance inductor is two.

3. The piezoelectric type resonance high-voltage light-starting circuit as claimed in claim 2, wherein
said two resonance inductors are connected in parallel with said piezoelectric capacitor, or said two resonance inductors is connected in series with said piezoelectric capacitor respectively.

4. The piezoelectric type resonance high-voltage light-starting circuit as claimed in claim 1, wherein
said light tube is a single piece of the following: a High-lntensity-Discharge Lamp (HID), a Metal Halide Lamp, a Ceramic Poles Fluorescent Lamp (CPFL), a Cold Cathode Fluorescence Lamp (CCFL), an External Electrode Fluorescent Lamp (EEFL), a Compact Fluorescent Lamp (CFL), or a Light Emitting Diode (LED).

5. The piezoelectric type resonance high-voltage light-starting circuit as claimed in claim 1, wherein
said light tube is a parallel connection of a plurality pieces of the following: a High-Intensity-Discharge Lamp (HID), a Metal Halide Lamp, a Ceramic Poles Fluorescent Lamp (CPFL), a Cold Cathode Fluorescence Lamp (CCFL), an External Electrode Fluorescent Lamp (EEFL), a Compact Fluorescent Lamp (CFL), or a Light Emitting Diode (LED).

6. The piezoelectric type resonance high-voltage light-starting circuit as claimed in claim 1, further comprising:
an auxiliary capacitor, connected in series with said light tube.

7. The piezoelectric type resonance high-voltage light-starting circuit as claimed in claim 6, wherein
said auxiliary capacitor is another piezoelectric capacitor.

8. The piezoelectric type resonance high-voltage light-starting circuit as claimed in claim 6, wherein
said number of said auxiliary capacitor is two, and said light tube is series connected between said two auxiliary capacitors.

9. The piezoelectric type resonance high-voltage light-starting circuit as claimed in claim 8, wherein
said two auxiliary capacitors are connected in series with said resonance inductor respectively.

10. The piezoelectric type resonance high-voltage light-starting circuit as claimed in claim 6, wherein
each of said light tubes is connected in series with said auxiliary capacitors and said resonance inductor respectively.

11. The piezoelectric type resonance high-voltage light-starting circuit as claimed in claim 1, wherein
said piezoelectric substrate and said two conduction layers are of a round shape, and said two conduction layers are formed on a whole or a part of said upper surface and said lower surface of said piezoelectric substrate.

12. The piezoelectric type resonance high-voltage light-starting circuit as claimed in claim 1, wherein
said two conduction layers are made of a silver paste, a copper paste, or a nickel paste.
